(19) United States
(12) Patent Application Publication
(10) Pub. No.: US 2012/0011006 A1
(43) Pub. Date: Jan. 12, 2012

(54) System And Method For Real-Time Analysis Of Opinion Data

(76) Inventors: Richard Schultz, Woodbridge, CT (US); Patrick Shields, Chapel Hill, NC (US)

(21) Appl. No.: 13/179,090

(22) Filed: Jul. 8, 2011

Related U.S. Application Data
(60) Provisional application No. 61/362,864, filed on Jul. 9, 2010.

(51) Int. Cl. G06F 15/16

(52) U.S. Cl. 705/14.73; 705/14.4; 709/203

(57) ABSTRACT

A system and method for providing surveys includes a server that allows client devices to access surveys over the Internet. The survey may overlap some content, such as a television show, and a user is given a mechanism for providing real-time attitude about the content by expressing either positive or negative reactions. The user's opinion data is aggregated with other users' opinion data and provided as a graph along a timeline in real-time.

### CROSS-REFERENCE TO RELATED APPLICATIONS

This patent application claims the benefit, under 35 U.S.C. §119(e), of U.S. Provisional Patent Application Ser. No. 61/362,864, filed on Jul. 9, 2010, the content of which is incorporated herein by reference in its entirety.

### FIELD OF THE INVENTION

The present teachings relate generally to opinion surveys and, more particularly, to a system for the real-time collection, analysis and dissemination of opinion data.

### BACKGROUND OF THE INVENTION

The real-time collection of opinion data has been used in the past to gauge the reactions of participants in focus groups as they experience an event. A focus group is a form of qualitative research in which a group of people are gathered in a controlled environment and asked about their perceptions. Focus groups are seen as an important tool for acquiring feedback regarding new products, as well as various topics. For example, focus groups have been used to collect opinion data regarding the language used in political speeches.

When vetting a political speech, for example, focus group participants have been given a dial which allows them to indicate positive or negative reactions by turning the dial one way or another. As the speech progresses, focus group participants are able to indicate their positive or negative reactions. The participants' opinions are aggregated and represented on a timeline as a graph. This is known as the “Luntz Meter.”

Based upon this timeline of data, the organizer of the focus group can analyze the success of particular language used in a political speech. For example, if at a certain point during the speech the participants' aggregated opinion becomes negative, this indicates that they did not respond favorably to the language in this part of the speech. The speech language may be modified accordingly.

U.S. Pat. No. 7,319,863 to Engstrom, the content of which is incorporated herein by reference in its entirety, discloses a system for providing an opinion with a mobile telecommunications device. Engstrom discloses where a user can evaluate a certain item, such as a song or a restaurant, by expressing a positive and negative opinion.

What is needed is a system that allows users to provide real-time opinion data with mobile devices. What is further needed is the ability for users to create surveys or other content to elicit opinions, and further to analyze them in relation to each other. Therefore, it would be beneficial to have a superior system and method for real-time analysis of opinion data.

### SUMMARY OF THE INVENTION

The needs set forth herein as well as further and other needs and advantages are addressed by the present embodiments, which illustrate solutions and advantages described below.

The system of the present embodiment includes, but is not limited to: a database having a plurality of surveys, each survey eliciting opinion data relative to an associated subject matter; a server in electronic communication with the database, the server receiving user opinion data relative to at least one of the plurality of surveys from a client device over the Internet, and the server receiving a reply survey in reply to a first survey of the plurality of surveys, the reply survey associated with the first survey; and an analytics engine in electronic communication with the server. The analytics engine aggregates opinion data from a plurality of users and the aggregated opinion data is distributed to the client device.

In another embodiment, the system of the present embodiment includes, but is not limited to: a database having a plurality of surveys, each survey eliciting opinion data relative to an associated subject matter; a server in electronic communication with the database, the server receiving user opinion data relative to at least one of the plurality of surveys from a client device over the Internet; and an analytics engine in electronic communication with the server. The analytics engine aggregates opinion data from a plurality of users and the aggregated opinion data is distributed to the client device. A first survey of the plurality of surveys comprises a single answer question relating to a guess for the outcome of some aspect of the subject matter and a user's success in correctly guessing that outcome is tracked.

The method of the present embodiment includes the steps of, but is not limited to: providing a database having a plurality of surveys, each survey eliciting opinion data relative to an associated subject matter; providing a server in electronic communication with the database; receiving, with the server, user opinion data relative to at least one of the plurality of surveys from a client device over a network; receiving, with the server, a reply survey in reply to a first survey of the plurality of surveys, the reply survey associated with the first survey; aggregating opinion data from a plurality of users; and distributing the aggregated opinion data to the client device.

Other embodiments of the system and method are described in detail below and are also part of the present teachings.

For a better understanding of the present embodiments, together with other and further aspects thereof, reference is made to the accompanying drawings and detailed description, and its scope will be pointed out in the appended claims.

### BRIEF DESCRIPTION OF THE DRAWINGS

FIG. 1 is block diagram depicting one embodiment of the system according to the present teachings;

FIG. 2 is a screen shot depicting one embodiment of the graphical user interface (GUI) of the client device in the system of FIG. 1;

FIG. 3 is a schematic diagram depicting one embodiment of the flow of user feedback (e.g., opinion) in the system of FIG. 1;

FIG. 4 is a schematic diagram depicting one embodiment of offline analytics in the system of FIG. 1;

FIG. 5 is a schematic diagram depicting one embodiment of the data flow in the system of FIG. 1;

FIG. 6 is an illustration of one embodiment of the graphical user interface of a feed screen from the system of FIG. 1; and

FIG. 7 is an illustration of one embodiment of the graphical user interface of a rating screen from the system of FIG. 1.

### DETAILED DESCRIPTION OF THE INVENTION

The present teachings are described more fully hereinafter with reference to the accompanying drawings, in which the present embodiments are shown. The following description is presented for illustrative purposes only and the present teachings should not be limited to these embodiments. Any computer configuration and architecture satisfying the speed and interface requirements herein described may be suitable for implementing the system and method of the present embodiments.

The present teachings disclose a system (e.g., platform, etc.) for the real-time measurement, analysis, and visualization of opinion data, which can be shown to participants and viewers (e.g., users), although not limited thereto. In one embodiment, the present teachings combine real-time data collection and analysis with social networking. Doing so provides context to the collected opinion data so that it is not only mapped to real-time events, but also to the specific demographics of the participants.

One problem with known opinion data collection systems such as focus groups is that they are dependent upon the quality of a particular focus group and require significant infrastructure and resources. For example, potential participants across particular demographics must be identified, encouraged to participate, and then must physically attend the focus group, committing valuable time and effort to participate. Further, while the opinion data results may be represented in this private environment as a Luntz Meter, it is typically not shared (or available) publicly.

Crowdsourcing is the act of delegating tasks to a large group of people or a community (a crowd) through an open call. The group itself does not have to be cohesive; for example, a group of people may not know each other outside of a particular forum, but they nevertheless may form a crowd through their participation. Applying crowdsourcing techniques to real-time opinion data collection provides the ability to take into account the collective opinion of various groups of individuals (e.g., cross-sections of the population) rather than a limited focus group. This gives far more valuable information as participants may cross many different demographics and thus, opinions may be quite diverse.

Accordingly, one objective of the present teachings is to provide a system for the easy creation of robust real-time opinion surveys that may be provided through any number of different channels over the Internet (or some other network). This provides users with the ability to express their opinions on events (or other media content, etc., collectively generally referred to herein as the “subject matter”) as they happen, without the preparation or infrastructure of traditional focus groups. Real-time opinions may be contextualized with the opinions of others and aggregated in a way that conveys meaningful information. For example, in one embodiment statistical analysis may be used to ignore aberrations in opinion.

In one embodiment, although not limited thereto, the system of the present teachings includes a client application, a server application, a database, and an analytics engine. The client application may be adapted for any number of different client devices or technologies (e.g., web, mobile device, cable box, web applications like Facebook, Linkedin, etc.) in order to provide an opinion controller (e.g., meter, etc.) and real-time opinion data, although not limited thereto. The server application may “serve” the functionality of an opinion meter to the client application in order to collect real-time opinion data. For example, although not limited thereto, a user may use the client application to provide real-time opinion data regarding a television show as it is happening, which may be provided by the cable box on the television screen. This opinion data may be returned to the server application and a database may be provided for storing it. An analytics engine may analyze and/or aggregate users' opinion data in real-time or from the stored database data and subsequently display the results in real-time through various channels.

So designed, the present teachings provide an opinion data collection system that allows users to easily create, participate in, and analyze real-time surveys. These surveys may be provided in context with real-time events (e.g., may overlay subject matter, may be in reference to subject matter, etc.) and may contain additional questions and other stimuli to which users can react. The collected data may be stored and analyzed and the results of the analysis presented back to the user in real-time. Participants and viewers can interact with the results of the analysis through visualizations, and with the analysis itself. The stored data can also be used for “offline analysis” where sophisticated statistical and machine learning algorithms can give insight into the data.

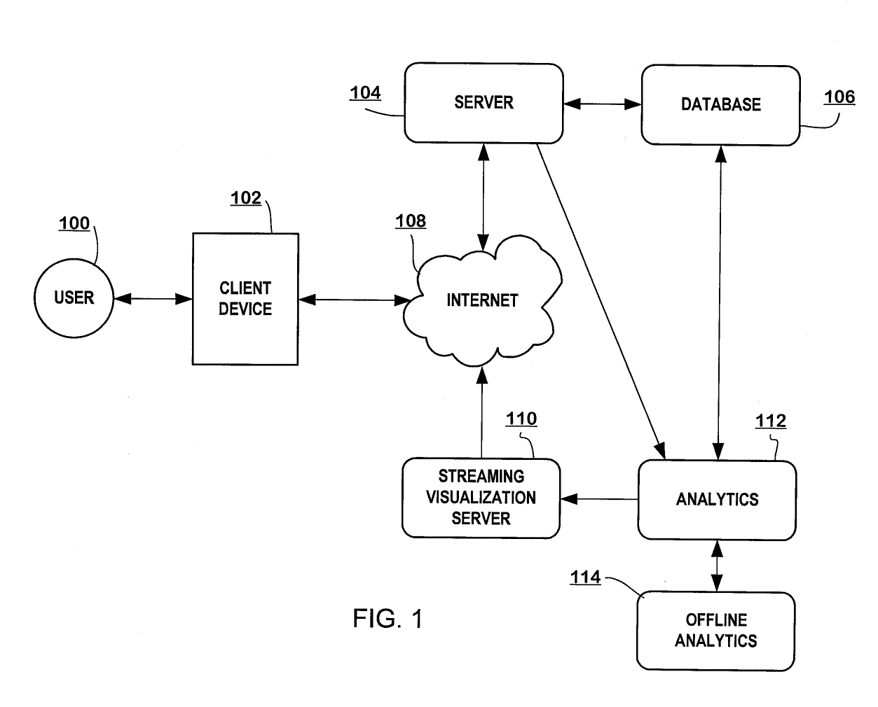

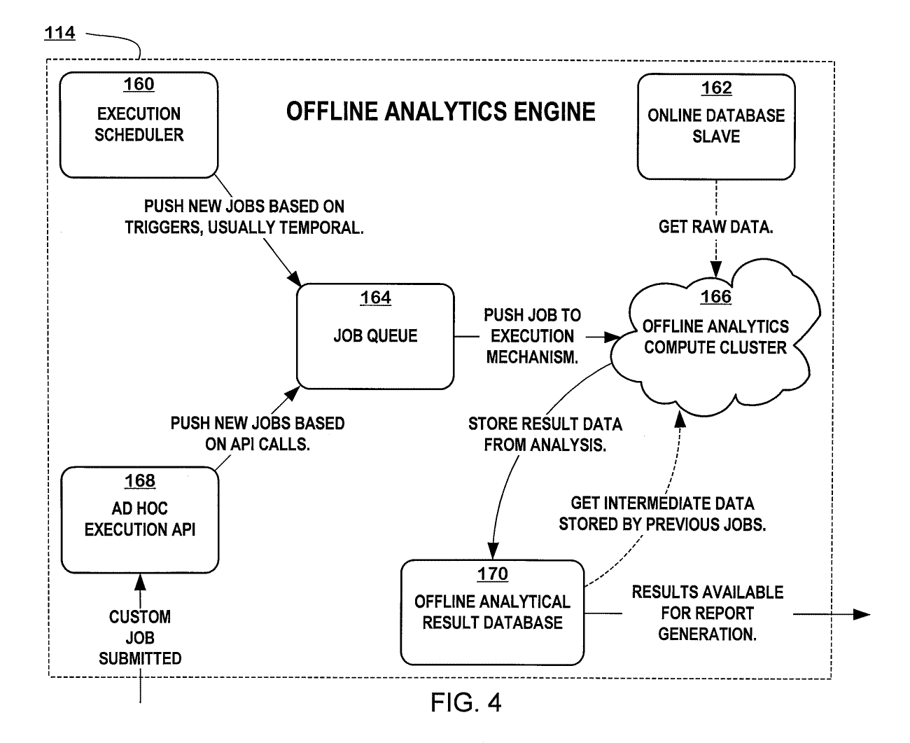

Referring now to FIG. 1, shown is block diagram depicting one embodiment of the system according to the present teachings. In its most basic form, the system may comprise a client device 102 used by a user 100 to access the system through a network such as the Internet 108, although not limited thereto. The system may have a server 104 that pulls data from a database 106 and is presented in an easy-to-understand graphical user interface (GUI) by a visualization server 110. The system may also comprise an analytics engine 112 which can aggregate and analyze the users' 100 opinion data in real-time and/or offline. Offline analytics 114 may be provided for more intensive analysis, discussed further below in relation to FIG. 4.

The visualization server 110 may act as a distributer for new analytic results. In this way, as soon as updated results become available, it may distribute them to the client devices 102 viewing that survey. The data may be sent in such a way that the visualization software on the client can successfully display it. It is to be appreciated that the server 104 and visualization server 110 may support a variety of different types of devices. For example, although not limited thereto, the system may be accessed through the Internet 108 or some other network by a web browser, cable box, handheld device, smart phone, tablet, PC, etc.

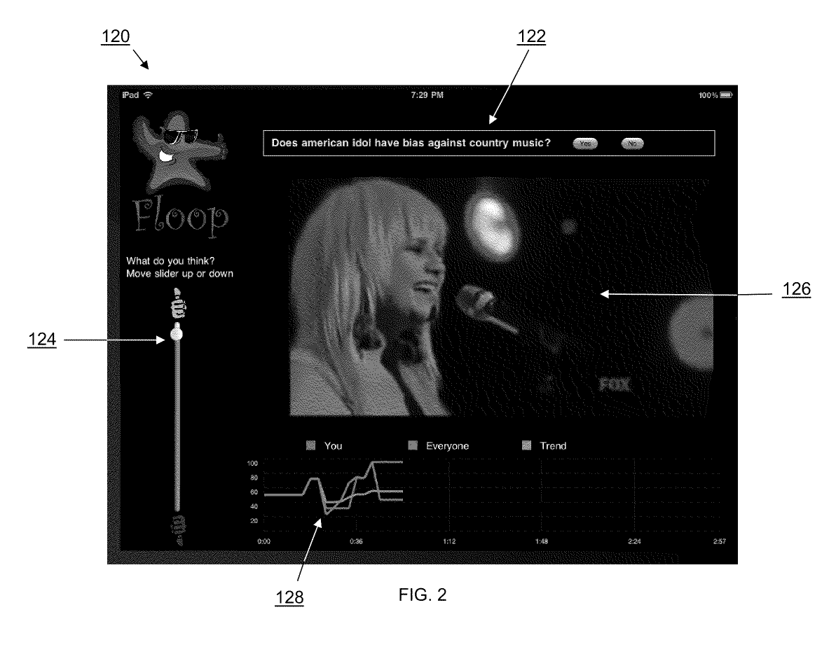

In such a way, the system according to the present teachings may provide a useful platform that is extendable to all devices with a generic application programming interface (API). In one embodiment, although not limited thereto, the survey and opinion meter (shown in FIG. 2) may overlay a webpage, television show, or some other event (e.g., subject matter) so that users 100 may provide real-time opinion data as the event is happening.

In one embodiment, a survey 120 may relate to text, such as a book, article, etc. The text may be shown and the user may provide opinion relating to the particular section that the user is currently viewing. For example, as the user scrolls down and reads the text, the user's opinion may change in relation to the scrolling.

In another embodiment, the survey 120 may be in relation to a some real-time event, although not limited thereto, and the subject matter 126 (e.g., event, etc.) may not be shown on the client device. For example, a survey may be tied to a particular geographic location, such as the location of a political rally, a concert, a restaurant/club, or some other location, although not limited thereto. In this way, the survey may elicit user opinion relative to that location (e.g., the atmosphere of the event, etc.) in real-time, at a particular time, or at pre-defined intervals, although not limited thereto. Based upon the location of user, which may be determined by a GPS (or some other locator device which may be accessed by the client device), the system may provide relevant (e.g., nearby, etc.) surveys for the user to participate in, such as by associating a survey with a client device by the geolocation of the client device, although not limited thereto. Access to surveys may also be restricted to client devices in a particular geographic location, although not limited thereto.

In one embodiment, a survey may elicit opinions from users such as by guessing an outcome. For example, a survey may relate to a baseball game and users may guess what they think the next pitch will be. The users may guess the next pitch and the system may store the user's success. Similarly, a survey may relate to a watching other types of events like poker games, and may elicit opinions regarding how the user would play a certain poker hand. It is to be appreciated that these are exemplary embodiments and the present teachings are not limited thereto. It is intended that the present teachings provide a robust and flexible system for creating surveys and obtaining user opinions. The system may track the user's success in guessing an outcome or playing a strategy, which may be automatically determined by the system based on provided results. For example, an RSS (Really Simple Syndication) feed or some other information provider may provide real-time results (e.g., the last pitch was a fastball, etc.) and the system may be able to automatically determine users' success. Users may also compete with each other in guessing outcomes.

In another embodiment, the survey may overlay some feed, such as a social network. In this way, a user may indicate his or her opinion on the “live feed” in real-time (or at some other predetermined time(s)). In this way, the real-time opinion relative to the feed of various content may provide a running analysis on the user's social network.

The present teachings may provide opinion data collection in a loosely coupled manner so as to assure the robustness and scalability of the system. Lightweight and optimistic protocols may be used in order to lower the complexity and cost. Database operations may be be carried out through traditional data persistence strategies, with the exception of incoming feedback (or responses) from users, although not limited thereto. While this may be persisted in a traditional fashion, it may also trigger an “event” within the system which causes analytics to be re-run on the newly collected data. The results of these analytics may then be delivered to all users 100 who are following the survey as well as those who may join before new responses have been submitted. The system may ensure that only one of these “events” exists at any time per question per analytic, although not limited thereto.

Referring now to FIG. 2, shown is a screen shot depicting one embodiment of the graphical user interface (GUI) of the client device 102 system of FIG. 1. As shown, the survey 120 may overlap some subject matter 126 (e.g., media content, etc.) such as a television show or some other event, although not limited thereto. In another embodiment, the survey 120 may be in relation to some real-time event, although not limited thereto, and the subject matter 126 (e.g., event, etc.) may not be shown on the client device. An opinion meter 124 (e.g., controller) allows a user 100 (shown in FIG. 1) to easily and intuitively express their opinion in relation to the subject matter 126. This interface allows quicker analysis, which may be shown as a graph 128 representing attitude versus time, although not limited thereto. In one embodiment, the graph may depict a specific users' attitude, the aggregated attitude of all users, or some subset thereof (e.g., demographic, social network, geographic proximity, etc.), although not limited thereto. The graph 128 may depict positive or negative attitude in real-time as the even occurs.

It is to be appreciated that use of the term “survey” herein refers to eliciting of user opinion in relation to some subject matter 126 (e.g., media content, event, question, etc.). It may be static and/or continuous. For example, a survey may comprise one or more questions, although not limited thereto. In another embodiment, the “survey” may simply comprise a title of an event (subject matter 126), and users may provide their real-time opinion in relation to the event.

It may be preferable in certain embodiments to post additional questions 122 to the survey. This may provide the opportunity to get users' views on a variety of topics while they are engaged by the survey. Results may be accumulated and posted back to the user in real-time, although not limited thereto. Survey organizers may also schedule questions to occur at different times during the survey. It is to be appreciated that user's may provide a number of different types of data to the system. For example, questions 122 may relate to a survey and provide opinion data as well as guesses (e.g., what do you think next baseball pitch will be?). The system may track the types of questions that may be relevant in analyzing the user's responses.

Additional questions 122 may be surveys in their own right. For example, in one embodiment, a question may be a reply to another survey. For example, a user may post a question to a first survey (e.g., the question is a second survey) that is then associated with the first survey. Opinion data for the second survey (e.g., the posted question) may then inform the opinion data of the first survey and associated subject matter. For example, the second survey may show users' interest in a particular aspect of the first survey, although not limited thereto.

A user can access the system via a number of different client applications, and the present teachings are not limited to this particular embodiment. For example, a user may access the system through a mobile application on their smart phone or other mobile device. Once connected to the system, the user may create a new survey, giving it a name. Users of the system may create surveys based on an occurring event (e.g., tonight's television episode, etc.), abstract concepts, or join existing surveys. Users of all kinds (participants, creators, and viewers) may connect with each other through these surveys and other social networks. This allows users to find surveys not only based on their interests or searches, but by the people they connect with. Users may also “reply” to a survey with a new survey, discussed further below.

Users may create accounts to access the system or may rely on credentials authenticated by some other system (e.g., a Passport, OpenID, etc.). A “profile” associated with an account may provide the system with demographic information that gives greater context to opinion data. For example, at any given point during a survey a female aged 12-18 living in a metropolitan area may have a different attitude than a male aged 35-45 living in a rural area. It is appreciated that the collected data can be shown in any number of different ways by using individual demographics and attitudes of the users (e.g., show me the demographics of the user's who most enjoyed the second television commercial, etc.).

Users may also be rewarded for providing additional demographic information or participating in surveys, although not limited thereto. They may be encouraged by a rewards system that allows them to earn points (or some other value), although not limited thereto. This may foster a competitive atmosphere and keep users engaged. Points may be redeemed by companies who create surveys to gauge interest in particular marketing strategies and products, although not limited thereto.

Users may participate in multiple surveys but it may be preferable for them to concentrate only on one at a time. Therefore, the system may limit how many surveys a user may join. Once a survey has been created, users may invite others to join or may even publish a survey for general participation or to a particular group (e.g., post on Facebook wall, particular social network, etc.). In one embodiment, although not limited thereto, a graphical representation of available surveys may be shown to the user. This representation may show the user which surveys are hot (e.g., high rate of participation), which surveys the user's friends/contacts are clustering to, or even suggest surveys for the user. The user may also be provided with the ability to drill down on each survey to particular demographics and filter for surveys on any number of different attributes, although not limited thereto.

Users of the system can create friend networks and follow friends, be notified when friends participate in a survey, or invite friends to participate in surveys. The system may also provide the ability to follow a particular survey, enabling a user to drill down in the survey to find specific individuals. Surveys may, for example, although not limited thereto, list participating users and have filtering capabilities. With the social networking component, a user will be able to determine in real-time their friends' opinions (e.g., how friends are “voting” with their opinions, etc.).

On one level, the present teachings provide a system to gather market research and feedback from a large group of electronically connected users. This solves the problem of capturing opinion feedback from social networks through traditional methods, such as parsing text posted to a social networking site (e.g., Facebook statuses, Tweets, etc.). At another level, the present teachings solve issues related to the collection, storage, and analysis of huge volumes of data. On the front end, the system disclosed herein may provide a user-interface that is simple to use and understand (e.g., pre-defined widgets for providing opinion feedback, and pre-defined graphing and display elements for conveying analytics). On the visualization side, the system may provide a mechanism with a specific look and feel for viewing the universe of surveys and for drilling down to discover hotspots, user clusters, friends, etc.

It is to be appreciated that private surveys may also be created. For example, before a sales presentation the presenter may send the survey to invitees. Similarly, the present teachings may be useful for conferences, lectures, or even for online marketing whereby a presentation is distributed with an overlaid survey, although not limited thereto. This way, a survey organizer is able to determine the effectiveness of a presentation or marketing campaign.

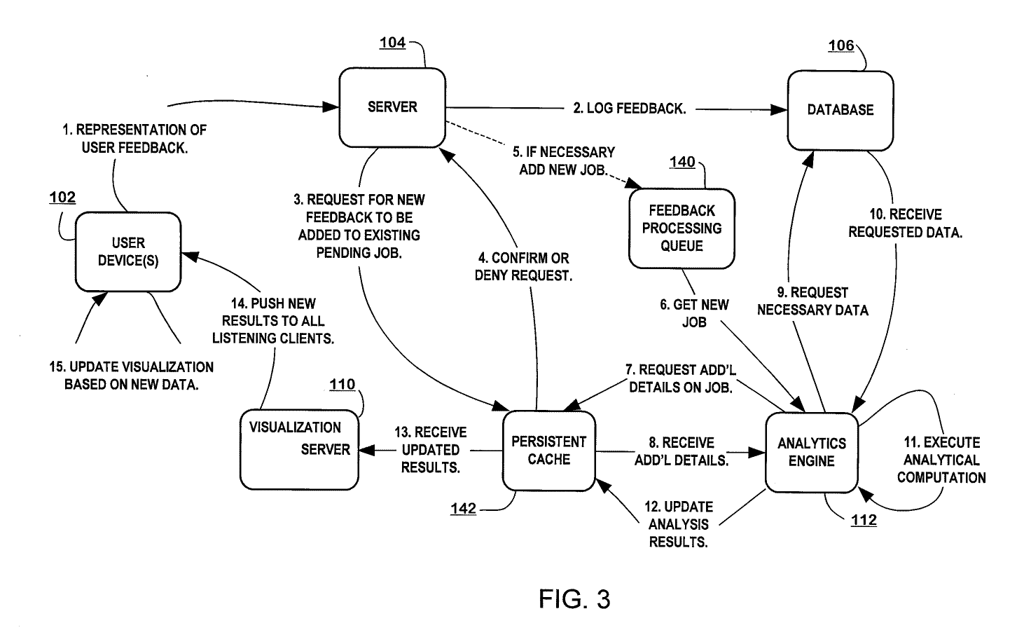

Referring to FIG. 3, shown is a schematic diagram depicting one embodiment of the flow of user feedback (e.g., opinion) in the system of FIG. 1. FIG. 3 displays the actions associated with the reception of user feedback in one embodiment. User feedback may cause analytics to be run and new visualization data to be pushed to users in real-time. Other user actions may follow a much simpler model, where the web server 104 deals with all communication, though it may often consult the database 106, although not limited thereto.

In one embodiment, the server-side infrastructure may be event driven. The primary event, submission of user feedback, is shown. While other interactions from the user may also cause state changes, such as the creation of a survey, the submission of feedback may touch other components of this infrastructure. The data may be stored, aggregated, analyzed and then sent back to the user's device 102. After the feedback is received and stored in the database 106, the web server 104 may complete the submission request by following a protocol of communication between itself, a persistent cache 142 and a queue 140. This protocol may be designed to maximize the amount of work done by the analytics engine 112 for every job it receives from the queue 140. The protocol may allow multiple jobs on the same survey to be aggregated into one job, which greatly increases efficiency. After running the statistical algorithms in the analytics engine 112, the new results may be put into an appropriate format to be visualized by the visualization server 110 on the client device 102 and the persistent cache 142 and visualization server 110 may follow appropriate protocols to ensure that this data is distributed to all applicable users.

As can be appreciated, access to such real-time opinion data can be very valuable and survey organizers may even dynamically change content based on the real-time data. For example, although not limited thereto, an advertiser may not want to run a certain commercial at a particular time if users' (or some demographics') attitudes are either very positive or negative.

Referring to FIG. 4, shown is a schematic diagram depicting one embodiment of offline analytics 114 in the system of FIG. 1. Analytics may show real-time moving averages and statistical analysis can throw out bad data. Shown is one embodiment of the communication at work in the “offline server components.” These components may be used in more sophisticated analysis of the data, which may or may not be shown to users.

The offline analytics 114 of the system may be designed to handle more complex statistical analysis than is available in the real-time analytics engine 112 (shown in FIG. 1). Because these analyses may not be done in real-time, there may be a number of different mechanisms for triggering jobs. One may be an API 168 for adding jobs in an ad-hoc fashion. Another may be an execution scheduler 160 to allow jobs to be added at predetermined times. This can either be a specific time, e.g., re-run analysis on survey #325 at 3 PM, or more generally, e.g., re-run analysis on survey #325 bi-hourly, although not limited thereto. All jobs from either of these sources may be routed through a job queue 164 into the distributed computing cluster 166. The analytics here may have access to all the data from “online” sources 162 and data from previously executed jobs with the offline analytics 170. Both open and proprietary analytics may be available in the cluster. Jobs that run on the cluster may dump any raw data into databases and then trigger the generation of reports.

Analytics may be separated by types of user input including, for example, although not limited thereto, single answer questions (SAQs) or continuous answer questions (CAQs). SAQs are multiple-choice questions that the user may only answer once (e.g., additional question 122 shown in FIG. 2). The same question may be asked later, but in general, the question will be asked once and answered once. An example of this might be “Do you like iced tea?” For these sorts of questions, there may be two main types of analyses, although not limited thereto: counts and other basic aggregations and clustering. The aggregations are fairly self-explanatory—they will simply show the distribution of feedback amongst the various possible answers. The clustering may attempt to find patterns between how groups of users are responding to the multiple-choice questions in the survey. One application of this is to tell the user which of his or her friends are responding to this survey most like them.

CAQs are questions that the user can answer repeatedly. The input, while still technically multiple choice, may be presented in a less coarse-grained way such as a slider or dial (e.g., opinion meter 124 or controller shown in FIG. 2). An example of this type of question would be “How do you like this show?” It is also possible for these sorts of questions to be implicit, such that the user is presented only with a topic or piece of media and a controller (like a slider). In addition to the analytics described above, these questions may contain some additional analytics due to their more time-sensitive nature. Windowed averages of all feedback for each of the CAQs may be calculated and the user may be given access to windowed averages of specific groups. For example users might see the average from only their friends' responses, or only people from Switzerland, although not limited thereto.

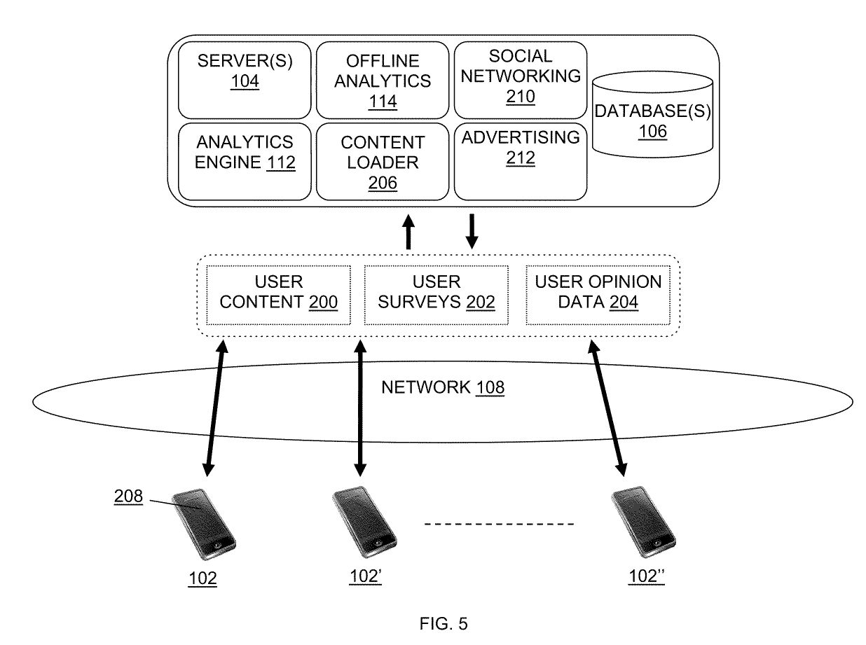

Referring now to FIG. 5, shown is a schematic diagram depicting one embodiment of the data flow in the system of FIG. 1. As discussed, users may create surveys and upload content (e.g., questions, comments, media content, etc.) into the system. Using client devices 102, 102′, 102″, users can access the surveys over a network 108 such as the Internet. For example, although not limited thereto, client devices 102, 102′, 102″ may include a smart phone (e.g., iPhone, etc.) and a mobile application may provide the graphical user interface to interact with surveys.

Users may create surveys 202 using client devices 102, 102′, 102″, which may then be stored in the database 106. Users may access the surveys 202 and provide opinion data 204, which may also be stored in the database 106 and/or analyzed 112, 114. User opinion data 204 may comprise any content the user uploads to the system, including real-time opinion data (e.g., CAQs, etc.), answers to questions (e.g., SAQs, etc.), guesses, etc. For example, in one embodiment users may post questions to a survey whether or not they are the survey creator. This way, users can create relationships of surveys, whereby subsequent surveys are associated with “parent” surveys.

In one embodiment, although not limited thereto, a user may create a survey 202 in relation to an event or geographic area. In this example, user A may respond to a survey created by user B which contains the text “Is this guitar player any good?”, and having a photo of the guitar player, and relating to the location of user B and the guitar player (e.g., User B may be at a concert where the guitar player is playing). In this way, User A's response to user B and his/her content is not simply limited to a general notion of guitar player X, but may be specifically tied to the guitar player's current playing. Using the system according to the present teachings, users may create surveys with ease, which may then be distributed to users through their client devices 102, 102′, 102″.

In one embodiment, users may upload user content 200 for storage in the database 106. For example, users may upload audio, video, pictures, text, web links, or some other content using client devices 102, 102′, 102″. The user content 200 may be received by a content loader 206 for storage in the database 106. The ability to upload user content 200 may be preferable when creating surveys (e.g., “what do you think of this sweater?”), when posting questions, or at some other time, and the present teachings are not limited to any particular embodiment disclosed herein.

User content 200 may also include user profile information in one embodiment. This way, a user may provide demographic and/or preference information to the system. In this way, relevant surveys may be provided to the user, such as surveys that the user may prefer to receive. Profile information may also be used to analyze opinion data, for example, by segmenting results by particular demographics, etc. In one embodiment, a social networking component 210 may provide the ability to see user's opinions and interact with users from particular social networks (e.g., including Facebook, Twitter, etc.).

In one embodiment, although not limited thereto, users may “reply” to a survey with another survey. This means that not only are the responses being created in real time, but the entire “poll” of surveys may be built collaboratively by users in real-time, with surveys associated with each other as new ones are created. The poll thus adjusts to the demands of the users, as new surveys “evolve” from pre-existing surveys, which may be based on human interaction as opposed to computer logic.

This presents a system in which users have the framework to make changes and create “communication loops.” This leads to multi-dimensional opinion data resulting from a running dialogue of surveys. The related surveys may change with each iteration but remain related (e.g., associated, etc.) with each other. In this way, the survey itself presents information relating to the opinions of the users. For example, changing survey content (e.g., modified survey topic, etc.) informs the changing views of users. In this way, surveys may overlap, be associated as parent/child, or relate in any number of different ways. The system may store the relationship between surveys for use in analysis.

One of the ramifications of this is that user response controls may have more subtle meanings. Since the labels on the control may not be tailored to the intention of the user creating the poll, they are, in part, open to interpretation by the user. Any limited instruction given to the user in the use of the control may try to establish some general “global semantics” for the control, but it may not change that the user is still interpreting the input as well.

Analytics 112, 114 may analyze and organize the opinion data and other content for distribution. For example, user opinion data may be aggregated and displayed on client devices 102, 102′, 102″ relative to a survey. More detailed analysis may provide for cross-referencing of related data. For example, although not limited thereto, offline analysis may generate detailed reports on particular subject-matter that may includes multiple surveys, and which may be related by association, content, geography, demographic or some other attribute, although not limited thereto. The analysis (e.g., aggregation, organization, etc.) may then be sold to customers. In one embodiment, customers may subscribe to predetermined subject matter and be delivered pertinent reports automatically.

An advertising component 212 may provide advertising content to users through the client devices 102, 102′, 102″. The advertising component 212 may identify advertising content relevant to a particular survey, subject matter, or some other user content. Advertising content may also be tailored to particular demographics, geographic location, social activity, or any other information available to the system. It is to be appreciated that one embodiment according to the present teachings includes a system and method for selling and displaying advertising in relation to surveys.

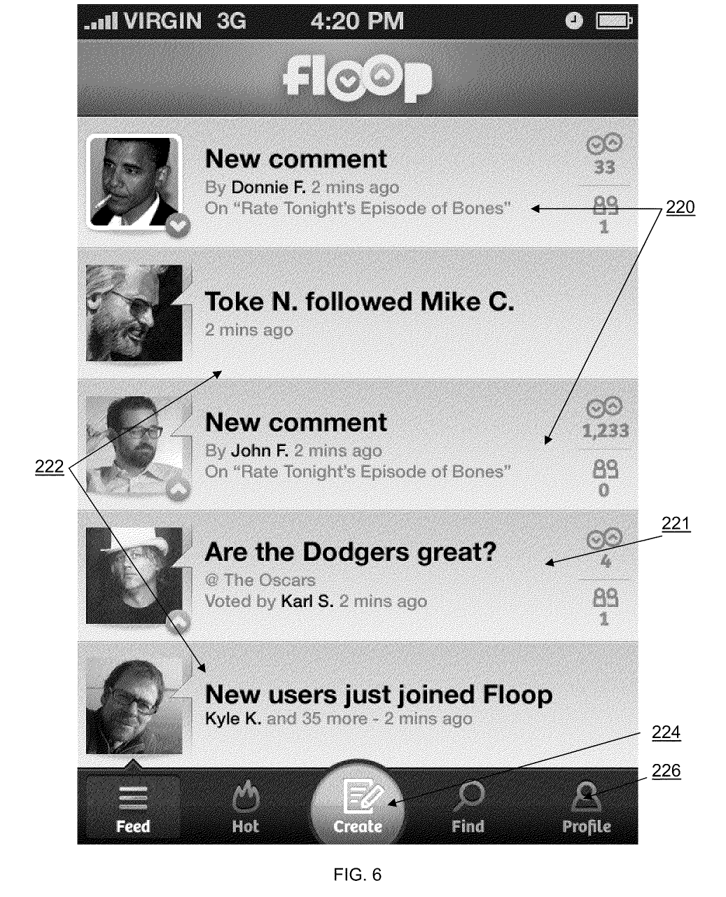

Referring now to FIG. 6, shown is an illustration of one embodiment of the graphical user interface of a feed screen from the system of FIG. 1. In one embodiment, the graphical user interface may be provided on a client device 102, 102′, 102″ (shown in FIG. 5) such as smart phone (e.g., iPhone, etc.). In this way, a user may interact with the system through a mobile application (e.g., iPhone app, etc.).

As shown in FIG. 6, the system may provide a live feed of activity, which may include survey activity 222, questions users ask in relation to a survey 221 (e.g., related surveys, etc.), and/or comments 220 users make in relation to surveys, although not limited thereto. The feed may provide data on more than one survey at a time. For example, all surveys in a particular social network, although not limited thereto. Users may easily create surveys 224 on the fly. Navigation controls also provide users the ability to search surveys, which may be organized by any number of different attributes. For example, surveys may be provided by subject matter, geo-location, social network, etc. The system may provide the ability to search for surveys, such as by “hot” (or active) surveys, which may be determined based in part on the participation of users within a particular social network, although not limited thereto.

Users may also access and edit a profile 226. A profile 226 may comprise demographic information for a user, including name, age, occupation, sex, income, race, religion, geolocation, etc. Such information may be useful for the system to analyze opinion data by a particular demographic, advertising to a particular demographic, or providing relevant surveys to a particular demographic, although not limited thereto.

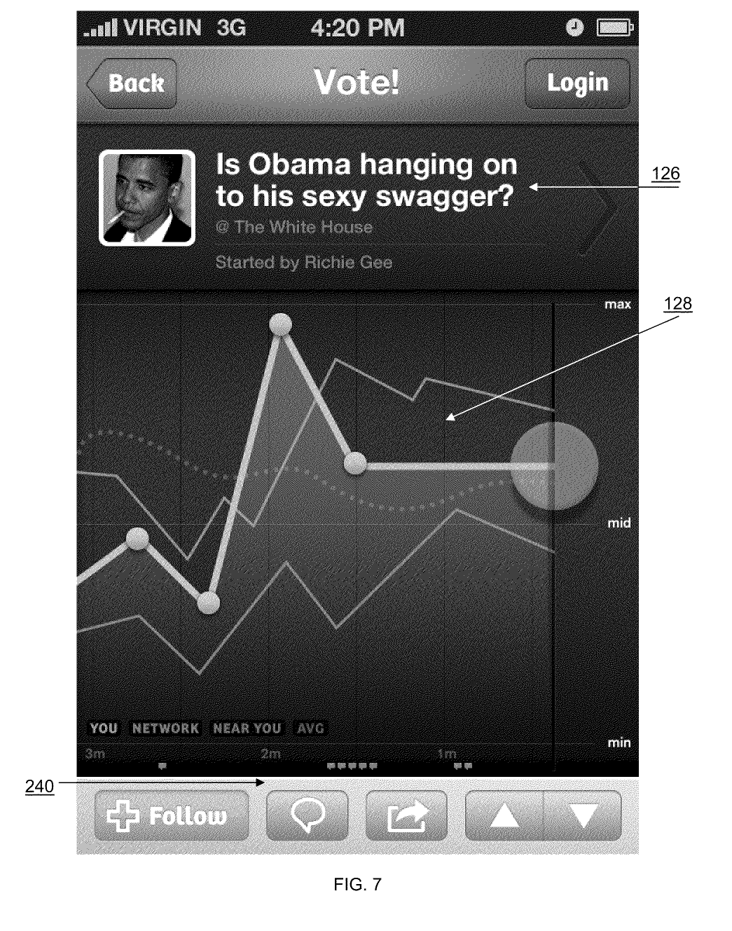

Referring now to FIG. 7, shown is an illustration of one embodiment of the graphical user interface of a rating screen from the system of FIG. 1. Survey subject matter 126 may simply be a title or question that relates to some external event, although not limited thereto. A user may provide real-time opinion data in relation to the subject matter 126 that may then be aggregated and displayed on a client device, such as an iPhone. Opinion data may be shown as a graph 128 representing opinion over a timeline. Aggregations of opinion data from any number of different demographics may be shown. For example, shown in FIG. 7 are opinion data from a user, and aggregated opinion data from the user's social network, aggregated opinion data from users proximate to the user, and an average.

Navigation controls 240 may allow a user to follow a survey, comment, share a survey on social networks (e.g., post to wall, tweet, etc.), and navigate between surveys (e.g., related by association, geography, subject-matter, topic, etc.), although not limited thereto.

While the present teachings have been described above in terms of specific embodiments, it is to be understood that they are not limited to these disclosed embodiments. Many modifications and other embodiments will come to mind to those skilled in the art to which this pertains, and which are intended to be and are covered by both this disclosure and the appended claims. It is intended that the scope of the present teachings should be determined by proper interpretation and construction of the appended claims and their legal equivalents, as understood by those of skill in the art relying upon the disclosure in this specification and the attached drawings.

What is claimed is:

1. A system for analyzing opinion data, comprising:
a database having a plurality of surveys, each survey eliciting opinion data relative to an associated subject matter;
a server in electronic communication with the database, the server receiving user opinion data relative to at least one of the plurality of surveys from a client device over the Internet, and the server receiving a reply survey in reply to a first survey of the plurality of surveys, the reply survey associated with the first survey; and
an analytics engine in electronic communication with the server;
wherein the analytics engine aggregates opinion data from a plurality of users and the aggregated opinion data is distributed to the client device.

2. The system of claim 1, wherein the server receives the first survey from the client device.

3. The system of claim 1, wherein the first survey comprises a continuous answer question.

4. The system of claim 3, wherein user opinion data for the first survey comprises real-time opinion data and aggregated opinion data from a plurality of users for the first survey is associated with a timeline.

5. The system of claim 1, further comprising a social networking component having information relating to users in a social network, wherein opinion data is aggregated for users from the social network.

6. The system of claim 1, wherein the subject matter is distributed to the client device together with an associated survey.

7. The system of claim 1, further comprising a content loader in electronic communication with the database, the content loader receiving user content from the client device, wherein the user content is associated with a survey.

8. The system of claim 1, wherein the client device is a mobile device and at least one of the plurality of surveys is distributed to a mobile application on the client device.

9. The system of claim 1, wherein the client device is a cable box.

10. The system of claim 1, wherein the first survey is associated with a geographic location and the system associates the first survey with a client device by the geolocation of the client device.

11. The system of claim 1, further comprising an advertising component, wherein the advertising component distributes an advertisement to the client device associated with a survey or subject matter.

12. The system of claim 1, further comprising a user profile in electronic communication with the analytics engine, wherein the user profile comprises demographic information and the analytics engine associates user opinion data with the demographic information.

13. A method for analyzing opinion data, comprising the steps of:
providing a database having a plurality of surveys, each survey eliciting opinion data relative to an associated subject matter;
providing a server in electronic communication with the database;
receiving, with the server, user opinion data relative to at least one of the plurality of surveys from a client device over a network;
receiving, with the server, a reply survey in reply to a first survey of the plurality of surveys, the reply survey associated with the first survey;
aggregating opinion data from a plurality of users; and
distributing the aggregated opinion data to the client device.

14. The method of claim 13, further comprising the step of receiving the first survey from the client device.

15. The method of claim 13, wherein the first survey comprises a continuous answer question; user opinion data for the first survey comprises real-time opinion data; and aggregated opinion data for the first survey is associated with a timeline.

16. The method of claim 13, further comprising the step of distributing the subject matter to the client device.

17. The method of claim 13, wherein the client device is a mobile device and further comprising the step of distributing at least one of the plurality of surveys to a mobile application on the client device.

18. The method of claim 13, further comprising the step of distributing an advertisement to the client device associated with a survey or subject matter.

19. The method of claim 13, wherein the first survey is only available to predetermined recipients; and the associated subject matter comprises non-public information.

20. A system for analyzing opinion data, comprising:
a database having a plurality of surveys, each survey eliciting opinion data relative to an associated subject matter;
a server in electronic communication with the database, the server receiving user opinion data relative to at least one of the plurality of surveys from a client device over the Internet; and
an analytics engine in electronic communication with the server;
wherein the analytics engine aggregates opinion data from a plurality of users and the aggregated opinion data is distributed to the client device; and
wherein a first survey of the plurality of surveys comprises a single answer question relating to a guess for the outcome of some aspect of the subject matter and a user's success in correctly guessing that outcome is tracked.
